(19) United States
(12) Patent Application Publication
(10) Pub. No.: US 2015/0082355 A1
(43) Pub. Date: Mar. 19, 2015

(54) Method and Apparatus for Interfacing Broadcast Television and Video Displayed Media with Networked Components

(71) Applicant: Mark Tiddens, Solana Beach, CA (US)

(72) Inventor: Mark Tiddens, Solana Beach, CA (US)

(21) Appl. No.: 14/447,580

(22) Filed: Jul. 30, 2014

Related U.S. Application Data
(63) Continuation-in-part of application No. 13/084,457, filed on Apr. 11, 2011, now abandoned.
(60) Provisional application No. 61/322,883, filed on Apr. 11, 2010.

(51) Int. Cl. H04N 21/462; G06F 3/0484; G06F 3/0482; H04N 21/41; H04N 21/4223; H04N 21/4782; H04N 21/436; H04N 21/2665; H04N 21/431; G06F 3/0481; H04N 21/422

(52) U.S. Cl. CPC H04N 21/4622; G06F 3/04817; G06F 3/04842; G06F 3/0482; H04N 21/4126; H04N 21/42208; H04N 21/4782; H04N 21/43615; H04N 21/2665; H04N 21/4312; H04N 21/4223
USPC 725/48

(57) ABSTRACT

An interface system for interfacing media between a video display screen and any one of a plurality of electronic devices having media files as sources of displayed video for presentation on the video display. The device employs a microprocessor and software to provide an interface for networked electronic components operating over different communications protocols. Also provided is a graphic interface between a smartphone and the video display allowing the smartphone to operate as a remote control to command the system using generated icons for devices on the network achieved using actual photographs. A display screen on the smartphone allows for hand held remote viewing when a user leaves the room where the current video display is located.

This application is a Continuation in Part application to U.S. patent application Ser. No. 13/084,457 filed on Apr. 11, 2011, which claims priority to U.S. Provisional Patent Application Ser. No. 61/322,883 filed on Apr. 11, 2010, both of which are included herein in their entirety by this reference, thereto.

### FIELD OF THE INVENTION

The present invention relates to the presentation of video and images and other media on a video display such as a television or flat panel display engaged to a cable box, computer, or other input device. More particularly, it relates to an apparatus and method enabling bidirectional data flow for wirelessly interfacing the video display and media with computers on a local network, the internet, and broadcast television, allowing the user to employ a conventional television or high definition display for viewing media communicated from one or plurality of video sources concurrently. Control of the system is provided by a conventional remote control or a cellphone or smartphone.

### BACKGROUND OF THE INVENTION

With the advent of high definition television, homes and businesses in the United States have invested in the purchase of ever larger video displays with exceptionally high definition imaging capabilities. In recent years such flat and curved screen displays have propagated to occupy a prominent space in most homes and in many cases multiple spaces in many homes have such a high definition screen.

However, to date, most such high definition televisions as well as conventional televisions and displays, are adapted to display only programs broadcast by national networks and cable networks and engaged devices such as DVD players and games. Such displays have in recent years afforded the user multiple audio and video inputs to allow the user to connect the display to multiple sources of media in the form of video and/or audio.

However, a device to seamlessly connect such a flat or curved display to the internet and local networked computers, and concurrently allow the user to remotely control one or all of the resulting plurality of input sources from a single remote control, is still lacking. As of yet, no device or method has been provided to afford the user or owner of such a large panel display screen, to initiate an automatic screen-saving function which uses electronic images from a computer on the network as a slide show and/or screen saver. Further, the provision of such a device which enables the user to adapt a smart phone or PDA to control it, as well as communicate and display the same media being shown by the display on the smaller controller or smartphone or pad, has yet to be offered.

As a consequence, owners or users of video displays and high definition flat panel displays are left to their own devices on how to input multiple sources of audio and video, and control them in an organized fashion. Users who are connection-challenged so to speak, and unable to ascertain how to connect, for instance, to a home or business computer network, and/or one or more computers or other media-capable devices on the network, and/or the internet, have been left in the lurch. Consequently, such low-tech users tend to under-employ their very expensive large video displays which are so prominently positioned in their homes and businesses. Instead, such users view cable or satellite broadcast television on their large display and view their internet sessions on a small remote screen, and view video and other media on their smartphone screens and have no means to move the media from one device to the other easily, nor to continue viewing the media of choice on a portable device when they are out of the room for a few minutes for instance to cook.

In the past and more recently, various solutions have been offered. “Web TV” was originally invented by Microsoft as an option to enable users to view the Internet on their TV. However, Web TV essentially hijacked the screen, ignored other video inputs, and displayed only video concerning the internet. Neither has there been any ability offered, to allow the user to use a video display for audio and video files which are resident on one or more computers of the local area network.

Still further, with the invention of electronic memory devices which require no power source to maintain electronic files, such as “thumb drives” and camera memory cards, another potential source of display audio and video and enjoyable media have become available. However, most available flat panel TV's and displays lack the ability of a simple interface with the memory cards. Instead they leave it to the frequently hapless owner or user to ascertain how to communicate data and media in memory on the memory cards to one or a plurality of media-capable devices in the home or office to display stored photos or video or other media on a TV flat screen, computer screen, laptop or other network-enabled device capable of employing the media file or link thereto for local display thereof.

Consequently, there is an unmet need for a device and method which allow for the individual or concurrent viewing of user-chosen media such as audio and video on their TV display, or other display-capable device in the home or office. Such a device and method should operate substantially independently of other devices, to ascertain the type and status of other forms of audio and video playback available locally and which identified component is capable of having media communicated to it, another device, or the user's large video display, and to automatically provide the user a chooseable means to communicate desired media to the appropriate chosen device or display.

Such a device and method should enable the user's display to operate as a TV or computer display or both, concurrently, when a user is present. Such a device should enable media chosen by the user from any networked or communicating device locally to be transferred and employed on any other media capable device locally. Such a device should enable the large panel TV display, a laptop, a pad computer, a desktop computer, a video game engaged to a display, or any other device in communication with the user device, to play media chosen by the user. For instance, the system should be able to cause the large panel TV display, or any other communicating component with a display engaged, to operate as a slide show using files from any computer device or electronic memory device operatively communicating on a local network. Such a device and method should be able to cause such a communication when the users are present, or when users are not present, thereby enabling the display to add electronic art to the room it occupies. Additionally, such a device and method should concurrently provide a means to interface electronic media files from one or a plurality of sources of such files such as in electronic memory stored media files in networked-component memory, on chip devices such as USB stick memory and camera memory cards, with the large panel video display screen, or with other display screens engaged with other network-engaged devices such as computers, laptops, video games, pad computers and smartphones.

Further, such a device should provide a means to allow the user to adapt smartphones and PDAs with display screens to employ a graphic interface to both control the system and transfer media between components, and to concurrently receive and display the media in the form of audio and video shown on the display screen on the screen of the PDA or smartphone. Such will allow the user to leave the room and still enjoy the programming being displayed. Ideally, such a device and method should be graphically enabled using the screen of the remote control device or the smartphone or similar component employed.

With respect to the above, before explaining at least one preferred embodiment of the invention in detail or in general, it is to be understood that the invention is not limited in its application to the details of employment and to the arrangement of the components or the steps set forth in the following description or illustrated in the drawings. The various apparatus and methods of the herein disclosed invention for interfacing local area network sources of audio and video with broadcast television on a single display, are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for implementing electronic interface components, displays, and software which allow for the easy interconnection of devices communicating on or with a local area network automatically to allow a chosen device or devices on the network display or employ the chosen media. It is important, therefore, that the embodiments, objects and claims herein, be regarded as including such equivalent construction and methodology insofar as they do not depart from the spirit and scope of the present invention.

### SUMMARY OF THE INVENTION

In accordance with the present invention, there is provided an apparatus and method to electronically control and engage a video display such as a high definition flat screen display panel, and interface the display in a bidirectional communication with one or a plurality of computers, video games, laptops, desktops, and/or other devices capable of employing media files to display video and/or reproduce sound and which are communicating with or connected on a local area network. The device and method also include software and hardware configured to communicate with the internet through the local area network, and to provide a graphic interface to the user of locally available networked components and to choose where to communicate the media in the form of video and audio to any one of the media playback capable components such as the large screen display panel, or smart phones or remote control components with screens or other communicating computer devices capable of media file replay.

### OBJECTS OF THE INVENTION

It is an object of the invention to enable an owner or user of a video display such as a television or flat panel display to interface the screen with one or a plurality of computers or electronic media storage or playback devices communicating with a local network.

It is another object of the invention to allow a user or owner of such electronic devices having displays, to employ the large screen display, for surfing the internet or playing a media file from another component on the network using a graphic interface and wireless communication with the local network.

It is another object of the invention to provide a means to communicate media files and links therefor, between the large screen display and the internet and also communicate such media files or links for employment with any networked computing device with a display, and do so automatically or with a graphic interface.

It is an additional object of the invention to provide a user-configurable screen saver or slide show which employs electronic images or media stored on any one or plurality of electronic devices having electronic memory in communication with a local area network.

A still further object of the invention is to provide software and bidirectional communications which allow for the employment of smartphones and PDAs to operate as a remote control for the communication of and display of electronic media files upon a display screen in communication with the local network either directly or as a connected screen to an electronic device.

It is another object of the invention to provide for the bidirectional communication between such PDA's and smartphones whereby the video displayed on and video display screen in the networked system is concurrently displayable on the small screen of a PDA or Smartphone used as the remote control to allow it to be taken to a remote location during play and display of the media.

An additional object of the invention is employing the device and interface method to communicate and to display electronic media files from a smartphone or PDA upon the larger display screens connected to the network in a home or office.

A still further object of the invention is to provide virtual inputs negating the need for a user to hook cables to a video display whereby a plurality of interface software windows are provided, each with a different source of media such as audio and video from broadcast programming, the internet, or electronic media files stored in electronic memory on a computing device or electronic memory device in communication with a local area network.

Another object of the invention is to provide a means for video conferencing to the user employing either the large video display or a communicating PDA or smartphone.

Yet another object of the invention is to provide the graphic interface for connection of networked devices using the video screen of the smartphone or PDA or Pad computer, and a graphic depiction using a photo or other means to generate icons or images of available devices for interconnection.

The foregoing has outlined some of the more pertinent objects of the invention provided by the apparatus and system herein. These objects should be construed to be merely illustrative of some of the more prominent features and applications of the intended invention. Many other beneficial results can be attained by applying the disclosed system and apparatus in a different manner or by modifying the invention within the scope of the disclosure.

Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

FIG. 1 is a graphic depiction of the bidirectional interface provided by the device and method herein with the internet, computers on a network, and smartphones and PDAs.

FIG. 2 is a block diagram view of the bidirectional communication flow provided by the device and method herein.

FIG. 3 depicts an optional but preferred provision of the system herein which allows for windows to display the plurality of display sources to the display.

FIG. 4 depicts an optional but preferred provision of the system whereby smartphones, cell phones and a PDA are enabled for bidirectional communication for controlling the system and displaying the video remotely to the cell phone or PDA or any other display screen operatively engaged with the network.

FIG. 4a depicts a mode of the system where the smartphone or controller with display screen may be pointed at the desired component and activated using the interface, or the accelerometer, to communicate wirelessly to move a media output, media file, or media link for display to that component.

FIG. 5 depicts a mode of the device wherein icons or photos of devices are depicted on a graphic display which are determined by software operating the system to be communicated with the local network.

FIG. 6 depicts the system providing discerned electronic network identifiers for the depicted components for user or software matching to the individual identified electronic components.

FIG. 7 depicts the discerned electronic identifiers, such as MAC IDs, having been matched to each networked device, either by the user using the graphic interface to slide the identifier onto a depicted component, or by the software using lookup tables on a networked database identifying manufacturer known MAC ID's for devices.

FIG. 8 the user has dragged the depicted identifiers to intersect the pixels representing the devices, and thereby provided the system software with relational matches of the depicted device to the electronic identifier on the LAN.

FIG. 9 depicts the screen of the system displayed for the user to input what media file, and/or link, and/or media or electronic output signal from another networked device to be connected to the user chosen network communicating device or devices.

### DETAILED DESCRIPTION OF THE PREFERRED EMBODIMENTS

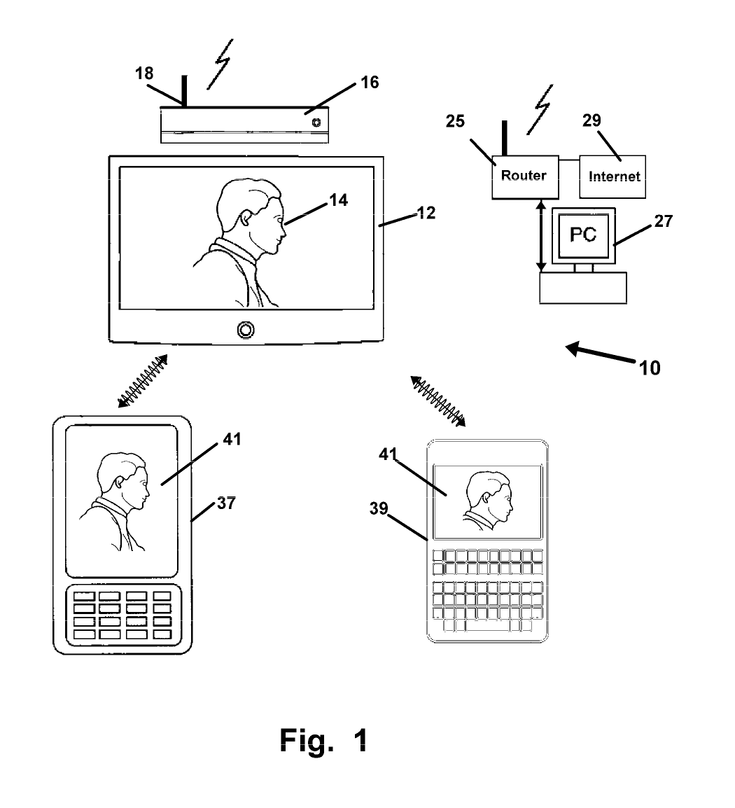

Referring now to the drawings 1-9, wherein similar parts of the disclosed system 10 and apparatus of the disclosed invention are identified by like reference numerals, there is seen in FIG. 1 a graphic depiction of the system 10 provided by the components and software configured to run upon them and employ the method herein disclosed.

As depicted there is shown the display screen 12 which may be a flat panel display such as an LCD Display or a Plasma Display or a projection display or cathode ray tube. As flat panel display screens 12 have become more common with the advent of high definition television, such displays with their multiple inputs for audio/video play are more probable. Depicted on the display screen 12 is displayed electronic media in the form of depicted video 14 which the system 10, employing software and interfaces running on a microprocessor operatively engaged thereto and located in a set top device 16, will ascertain and communicate in the proper audio and video standard to the display screen 12. This communication is provided over conventional cabling or wirelessly through one or a plurality of the conventional inputs and outputs provided and in operative engagement with the microprocessor on the set top device 16. Such electronic input connectors, and electronic output connectors, communicating with the exterior of the set-top device 16 and in operative engagement thereto, include one or a combination of electronic communication ports from a group of input ports consisting of HDMI, VGA, WiFi, Component Video, computer LAN (“IP” Internet Protocol Suite), and Component Audio connectors for cabling employing connectors for HDMI, component video, VGA, CAT5, and other conventional standard input and output connector ports adapted to engage the terminating ends of the correct cabling.

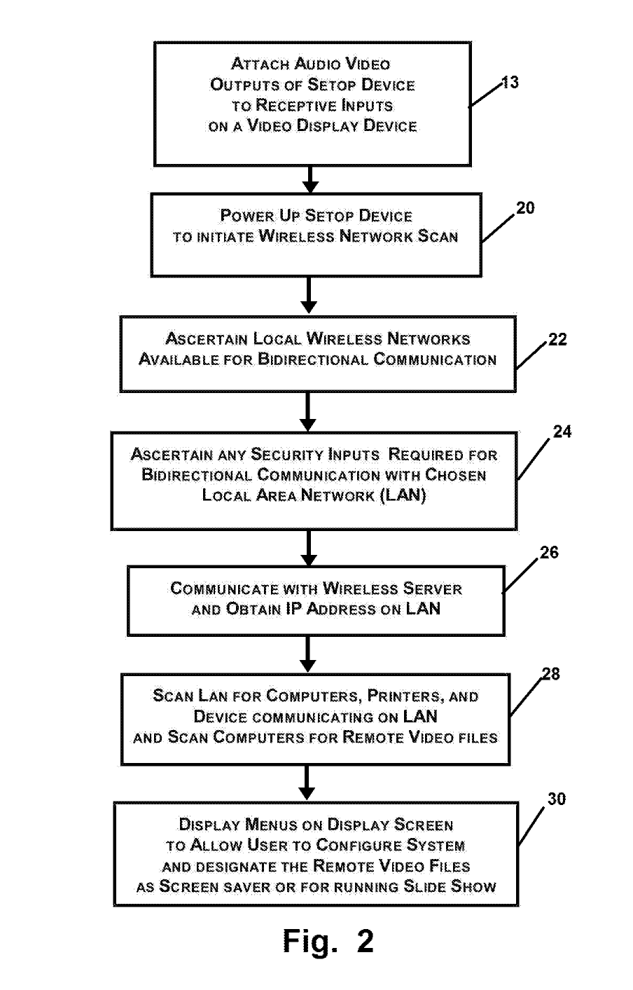

In a first step 13, (FIG. 2) a bidirectional communication between a set-top device 16 and the display screen 12 may be enabled through a cabled connection, preferably between an HDMI port of both the display screen 12 and that operatively engaged with the microprocessor on the set-top device 16. Employing the HDMI communication will provide means to communicate both video to the display screen 12 for the displayed video 14 and audio signals, if any, to speakers of the system.

The set-top device 12 may be standalone, or software enabled and resident on a networked computing device or included for instance in a cable-TV component box or satellite TV receiver and has onboard or access to electronic memory operatively engaged to its microprocessor which operates software configured to operate the system 10. The electronic memory enables the system 10 to operate with a microcomputer and employ software configured to provide the interface tasks herein for operations. The set top device 12 may, as noted, be virtual in that it is software running on a network communicating computing device, and in communication with sensors or receiving components for communications from the user operated component actuating the system 10. Such a computing device capable of running the software to actuate and enable the system functions are well known for instance in the form of a PC board with RAM memory and operatively engaged to one or both of a hard drive and electronic memory, and having the input and output connectors engaged to a buss, and appropriate software drivers for interfacing with the system software and the microprocessor.

The set-top device 12 or other component running the system 10 is operatively enabled with a wireless communication component 18 operatively engaged with the communication buss to the microprocessor or PC or other computing device running the system 10. The software running on the computing device enabling the system employs software drivers configured for wireless communication with other computers directly, or through a network router, optical broadcast, or other wireless means for communication on a local network.

The wireless communication component 18 operates on a frequency and employs conventional WiFi, Bluetooth, or other communication standards allowing for broadband high speed communication. Currently preferred is the employment of Bluetooth or more preferably the WiFi standard, since it is well established as a standard mode for bidirectional communication between components with high speed data transmission.

However, communication standards change and those skilled in the art will realize that any wireless communication, capable of interfacing and bidirectional communication at a high data rate may be employed to enable and operate the system 10 herein, and such is anticipated within the scope of this patent.

Once electronically engaged to the display screen 12, the set-top device 16 or other computing component when powered up 20 and employing the software configured to do so, will initiate a scanning 32 mode. In this scanning 32 mode, the component running system software such as a set-top device 16, will scan 32 the local airwaves 22, and also scan 32 the CAT5 system if connected, and ascertain any one or combination of wired or wireless local area networks (LAN) 22, on which it is adapted to communicate such as a WiFi network handled by a router 25. The LANs 22 available will then be probed to ascertain if security is enabled and if a security standard and password needs to be enabled for the wireless bidirectional communication with any electronic device on the chosen LAN 22. Such will then be input by the user in this scanning 32 and ascertaining step to give the system access to the LAN 22 whereby it may ascertain what components are connected thereto.

Subsequent to inputting any security inputs 24 for wireless or wired bidirectional communication with a chosen LAN 22, software adapted to the task and running on a computing device in operative communication with the LAN 22 such as a set-top device 16, will communicate with the LAN server or router 25, and obtain an IP address 26 on the LAN 22. With LAN 22 communication in wired or wireless mode, such servers or routers 25 conventionally employ a wired or wireless router 25 (FIG. 1) which serves to assign electronic addresses in the form of IP addresses, to each electronic device adapted to communicate on that LAN 22. This allows each device on the LAN 22 to interface with other devices thereon such as one or a plurality of networked computers 27, smartphones 37 or pad computers, laptops or PDA's 39, and other electronic devices configured and adapted to communicate upon the LAN 22. The router 25 and some devices communicating on the LAN 22 may also be adapted with software to communicate on a Wide Area Network such as the internet 29 through a wide area network (WAN) connection at the router 25.

The system 10, using a computing device such as the set top device 16 or other computing device on the LAN 22, upon obtaining access and an IP address on the LAN 22, and employing software running on its microprocessor and configured to the task, will employ software adapted to scan 32 the LAN for computers, printers, game consoles, laptops, pad computers, smartphones, smart televisions, and any other electronic devices communicating on the LAN 22 and identify them, and inventory the discerned devices in a database in accessible lookup memory. Conventionally, such electronic devices engaged with a network have a network communication component which has a unique electronic identifier. Such an electronic identifier currently widely employ is a MAC ID which is a unique identifier assigned to the electronic communication component of each device communicating with the LAN 22. The scan 32 of the LAN 22, will also employ software running on the computing device enabling and running the system 10 such as a set-top device 16, which is configured to ascertain the location of any electronic media such as video files or libraries present on all connected communicating electronic devices to the LAN 22.

The locations will be inventoried in a lookup file in memory which may be correlated to the individual devices engaged to the LAN 22 based on their unique identifier such as their MAC ID. Once ascertained, such video files may be employed or communicated by the system between devices for the displayed video 14 thereon, and/or to provide a screen-saving means or to provide an ongoing slide show on any display device 12 operatively engaged with the LAN 22 or an electronic component engaged therewith, such as the large screen display 12 when not in use by the user for TV or other media viewing.

This scanning 32 of the LAN 22 by the system 10 operating on a computing component engaged therewith, and inventorying and relating of video files to individual device identifiers in this step, is a particularly preferred component and step of operation of the system 10. This is because since it allows the user to employ the system 10 to ascertain each of the computing devices capable of using media files for video and audio reproduction, for instance, for providing ongoing slide shows on the TV display device 12 or the video display of another device on the LAN 22.

Further, if the display device 12 such as a large flatscreen TV lacks a screen-saver function, which can cause damage to the screen itself, the system 10 can provide that function in the form of these slide shows or random projections of found and communicated media video files found on the computers and devices ascertained as operatively engaged and communicating on the LAN 22 subsequent to a scan 32 for computers 28 and electronically stored media files such as video files thereon.

Optionally, but also preferred, the user may be given a menu to pick media such as video files discovered as stored in memory on electronic devices identified by their identifier as engaged to the LAN 22 during an initial or subsequent scan 32, and to designate a preferred device for projection or depiction of the known media such as for instance on the display device 12 used for TV due to its size. However, the system 10 may also default to finding caches of electronic images stored on individual computing devices and network storage devices, and the like which are identified by their unique electronic identifier, and other such communicating devices such as smartphones, game consoles, pad computers, laptops, and similar network enabled devices with video displays which are communicating on and with the LAN 22.

The system 10 having inventoried the electronic storage locations of the video files on devices electronically identified on the LAN 22, will then employ the media files so stored, to generate slide shows on the display device 12. The choosing of media files for projection of any display device 12 of any network-engaged device by the user, may be offered as part of a display of menus 30 allowing the user to also set up the operation of the system 10 using the onboard software configured to that task, and during subsequent operation in the chosen mode.

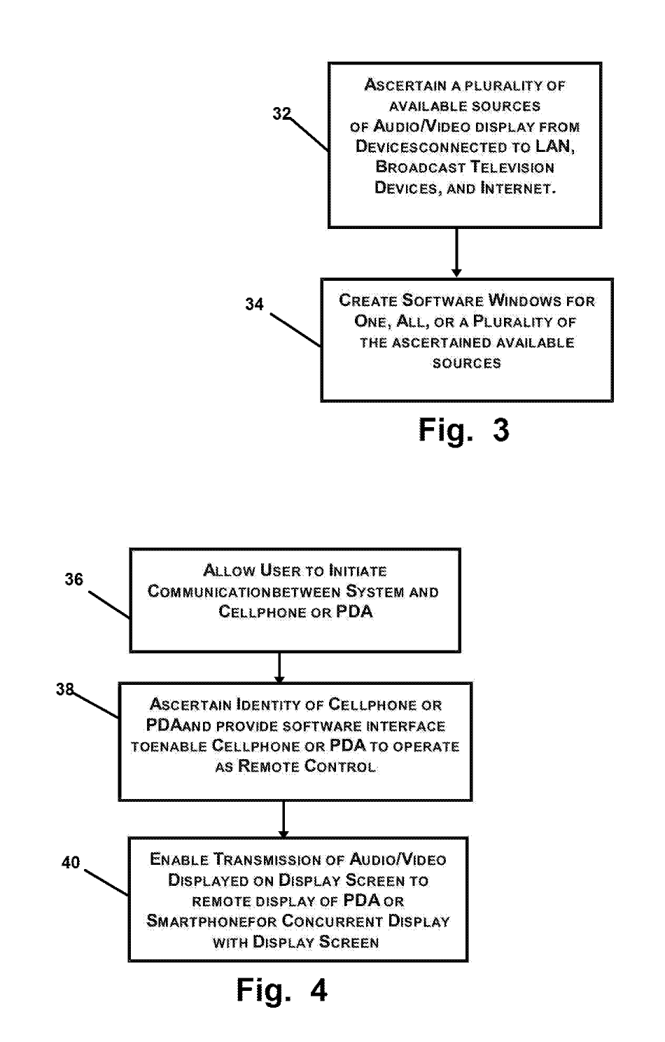

Another optional but preferred mode of the system 10 configuration is shown in the steps of FIG. 3 wherein a computing device engaged with the system 10 such as software running on the set-top device 16, will scan 32 the connected electronic devices on the LAN 22 for all devices connected with a electronic identifier and adapted for communicating with the set-top box 16 or other device running software configured to operate the system 10.

The scan 32 will discover the electronic identifiers such as MAC IDs of computers 27, devices engaged with the internet 29, smartphones, network engaged storage devices, and any memory device docks for stick memory or USB memory devices. This operation of the software running on the system 10 adapted to seek and find video files and communicating devices in the LAN 22 scanning 32, may be repeated daily or periodically by default and may as noted below be employed to generate graphic interfaces using photographs or assembled graphic interfaces for user-choice of engaged identified devices with which to communicate media files or display output.

From the scan 32 of the LAN 22 the software running on a computing device engaged with the LAN 22 such as on the set-top device 16, will generate and provide one or a plurality of windows or virtual displays relating to each electronic device or memory component ascertained as in operative communication on the LAN 22, and if the user is asked, chosen. This will allow the user to employ the display screen 12 to display one or a plurality of display windows with the displayed video 14 being different in each window for each source.

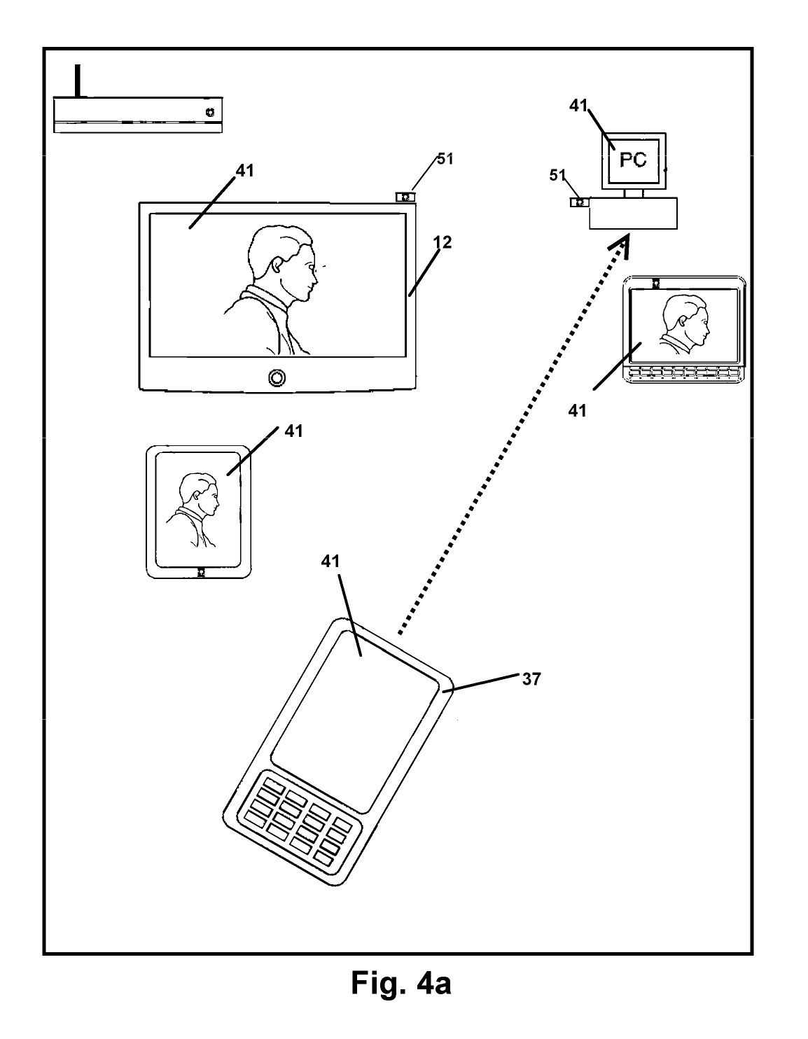

As shown in FIGS. 4, and 5-7 a particularly preferred mode of the system 10 will allow for the use of a smart phone such as the MOTOROLA DROID or the APPLE IPHONE, or a PDA or Pad Computer other electronic devices capable of wireless local communication, for instance over bluetooth, or using RF, to operate as the remote control 36 for the system 10. In this mode, the system 10 employing software configured to the task and running on the microprocessor of the set-top device 16, will initiate a bluetooth, or WiFi or other mode of wireless communication in an electronic handshake with the user's smartphone 37 or PDA 39 or other portable user device. The software running on the system 10 will thereafter identify the type of smartphone 37 or PDA 39 or similar portable user device answering a communicated handshake, and will then provide an interface 38 for the electronically identified and ascertained user device to operate as a remote control on the system 10.

The interface 38 may be communicated to the ascertained device to run thereon as an “app” in the form of a small software program, or the system 10 may discern the device ascertained by its electronic identifier in the handshake, has its own software capable of the task. Using the provided “app” or the ascertained device's onboard software, the system 10 will initiate communication which will allow for bidirectional communication between the computing device running the software for the system 10 such as the set-top device 16, and the identified smartphone or PDA.

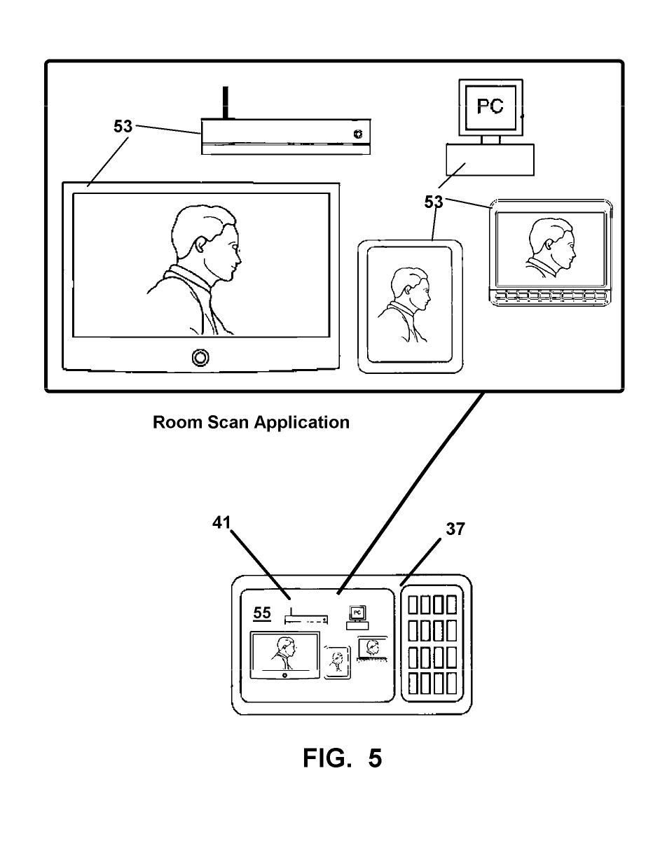

If the smartphone 37 or other controller employed has a display screen 41 such as in FIGS. 5-7, the provided graphic interface, especially if transmitted as an “app”, can also provide for a virtual control surface to be depicted on the screen 41 of the smartphone 37 or PDA 39 or other device display. This would be enabled by using a widget or the “app” communicated from the computing device running system 10 software such as the set-top device 16, once the software adapted to the task of identifying the respective portable device ascertains an electronic identity. Such will allow the user to customize the remote control provided by the smartphone 37 or PDA 39 to control the system 10 instead of using keys not specifically designed for such.

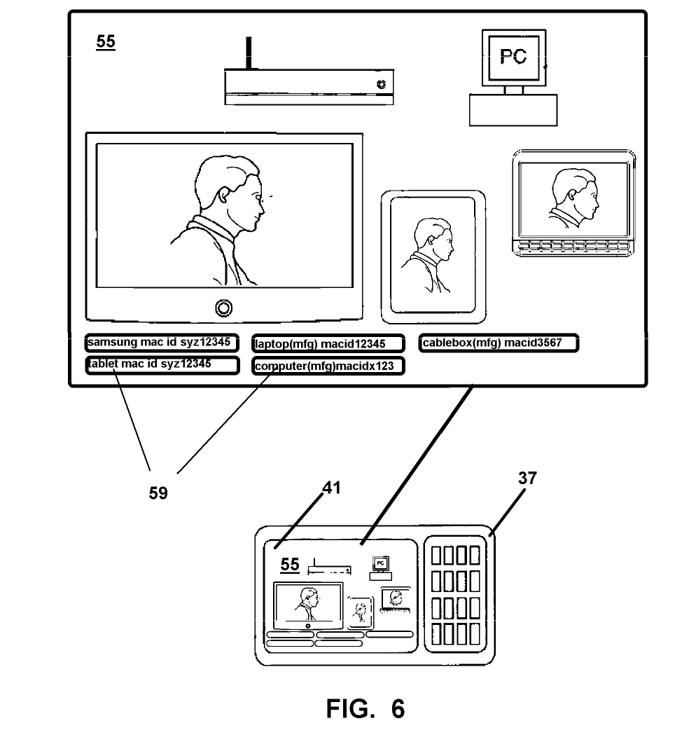

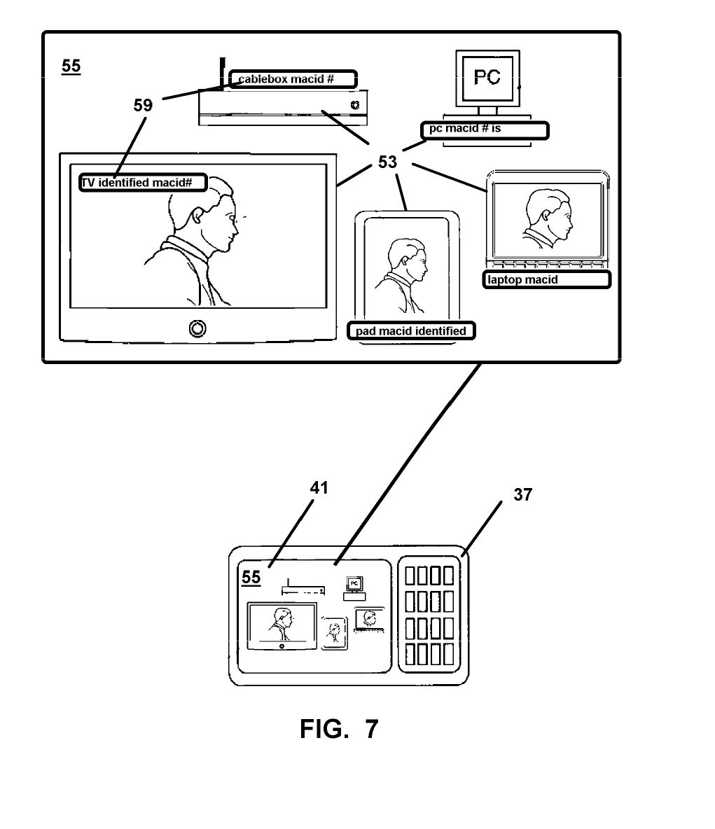

As shown in FIGS. 6-7 the graphic interface 55 may employ an actual electronic photograph of electronic devices present in a room in different positions, or the interface 55 can be an assembled interface 55, using multiple photos of the actual electronic components on the LAN 22 locally, and employing software adapted to the task of assembling them on a single page graphic interface 55. The photos of actual equipment thus can be the icons on the graphic interface 55 which may be matched to their respective electronic identifiers by the user, or by software running on the system 10 adapted to the task of looking up published or stored manufacturers MAC ID's or other identifiers, and matching them to the photos of the individual components serving as the icons for those components on the interface 55 page, as noted below.

Also particularly preferred, once the bidirectional communication with the smartphone 37 or similar portable computing device having a display 41 is achieved, the transmission on the LAN 22 of the signal rendering the displayed video 14, directly to the smartphone 37 or PDA 39 may be provided or to any other electronic device having a display 41 and identified on the LAN 22 and chosen by the user using the graphic interface 55 as a display device for media.

Communicating the electronic signal rendering the displayed video 14 and/or audio of the playing media or media file to the smartphone 37 or another user designated device on the LAN 22, will allow for a concurrent display of the displayed video 14, on both the display screen 12 such as the TV, and the screen 41 of the smartphone 37 or PDA 39 or similar device. Users thereby will have a transportable secondary display source of the media for the displayed video 14 and/or communicated audio, if they should leave the room where the main large display screen 12, or other display 41 for depicting the media is located, thereby allowing them to maintain a viewing and listening of a program or show.

In addition to allowing the smartphone 37 or PDA 39 or similar LAN-engaged electronic device to operate as the remote control for the system 10, and to depict the displayed video 14 on their respective small screens 41, the bidirectional communication of the system 10 employs software adapted to allow for video display upon the larger main display screen 12, of the media playing or stored on the smartphone 37 or PDA 39 or other identified electronic device operatively communicating on the LAN 22. Media such as photos, recordings, or even the database held on such portable devices will be able to be displayed upon and reviewed upon the display screen 12, or any electronic device on the LAN 22 of the system 10 which is chooseable using the graphic interface 55 such as in FIGS. 4-7.

As noted above, the system 10 employs software running on a computing device, which is configured to scan 32 the LAN 22 to identify the unique identifiers such as a MAC ID of any devices in operative wired or wireless communication on the LAN 22, and which may be employed in combination with the system 10 and with the other devices identified using their electronic identifiers. If a LAN-CONNECTED printer is identified, the system 10 using software configured to the task, running on the chosen computing device, will allow the user to print displayed media, of for instance, that which is depicted on a chosen display screen 12, or from the screen 41 of any communicating smartphone 37 or PDA 39 or similar portable device operating with the system 10. The control device as noted may be a remote control with a display 41 or more preferably a smartphone 37 or similar device in communication with the LAN 22 and so identified. The generated graphic interface 55 depicted on a display 41 would be operable using underlying software to direct the printing or communication of the depicted video to the various components on the system 10 capable of rendering it.

As noted, FIG. 4a depicts a mode of the system 10 where the smartphone 37 or controller with display screen 41 is running software adapted to enable the controller to be pointed at the desired electronic component in the room, such as the PC in FIG. 4a, which has been pre-associated with its electronic identifier. In this fashion the controller or smartphone 37 wirelessly commands the system 10 software, to communicate a media video output, media file, or media link, to be displayed on the screen 41 of the electronic component pointed out such as in FIG. 4a which is shown as the PC computer. Such may be accomplished by wireless communication by the smartphone 37 or screened controller, when pointed at the desired output component while pressing a button or tapping a graphic interface on the screen 41.

In a more preferred mode, the smartphone 37 or controller is flicked or moved in an arc and accelerated in a direction toward the chosen device, such as the PC computer, and the accelerometer present in most such devices ascertains the accelerated movement and direction as the choice signal, or input signal to broadcast a signal. An infrared pickup 51 related with the chosen device, such as the PC depicted in FIG. 4a, when the controller or smartphone 37 is pointed in its direction, will discern the wireless communication directed at it, and communicate such to the software of the system 10. The system 10 which will then employ software running on the system 10 adapted to the task of communicating the desired electronic communication of the media output, media file, or display signal, to the chosen device at which the smartphone 37 or controller was pointed and accelerated or otherwise caused to input a choice thereof.

FIG. 5 depicts a mode of the system 10 wherein icons 53 representative of the devices engaged with the LAN 22, which have been electronically captured with a camera, using a room or device scan mode of the system 10 software. The icons relating to each electronic device connected to the LAN 22 are related to electronic identifiers which may be positioned on a generated graphic interface 55 of the smartphone 37 or computing device having a display which will control the system 10 such as in FIG. 6. The icons 53 may be from a library of graphic depictions of electronic devices, or more preferably, will be actual photos of electronic devices having related electronic identifiers which are in operative communication on the LAN 22.

The icons 53 may be inserted on the main graphic interface 55 using photos taken by the electronic camera of the smartphone 37 user device, and inserted into the graphic interface 55 using software running on the system 10 or the smartphone 37 or similar device. This allows the user to actually take photos of their local LAN 22 connected devices using the smartphone 37 or other computer with photo ability, which the user will immediately recognize as the local electronic devices, rather than a generic graphic icon which might be confused with other devices. Or an actual photo of the room with the devices present might be employed.

During generation of the graphic interface 55, if photos are taken of one or a group of the electronic devices engaged with the LAN 22, software adapted to product recognition, which operates much like facial recognition, can employ the captured photos in electronic memory to ascertain the manufacturer and model of the photographed devices. These may be cross referenced with published industry MAC ID numbers and groups thereof, relating to individual different manufacturers by the software operating the system 10, to ascertain which electronic identifier if it is a MAC ID, relates to or matches which photo being employed as an icon 53, to pre-configure the graphic interface 55 to know which electronic device identifier matches which photo derived icon. Thus, when a user touches or otherwise chooses a device, for depiction or communication of media or files or feeds, the system 10 will communicate such to the device on the LAN 22 which has the MAC ID or other identifier discerned as matching the icon.

For occurrences where the system 10 cannot employ software to compare photos of devices operatively engaged with the LAN 22, to known or discernable electronic identifiers, FIG. 6 depicts the system 10 providing depictions of discerned electronic network identifiers 59 discerned by the system 10 software in a scan of the LAN 22. The user may then match the depicted identifiers 59 to the icon representing the respective device on the LAN 22 to which the depicted identifier 59 relates. Thereafter a touch or other designation of an icon on the graphic interface 55 will be employed by the system 10 to communicate to and/or from the designated device icon on the interface 55 based on its LAN 22 unique identifier. While not as convenient as using software to discern the actual device using recognition thereof, and then matching it to known MAC ID's or identifiers automatically, this mode still allows the user to employ a graphic interface 55 compiled using a photo of a room with the devices in it, or individual photos of the devices which are placed onto the interface 55 for designation actions by the user later on.

FIG. 7 depicts the discerned electronic identifiers 59, such as MAC IDs, having been matched to each networked device and its icon 53, either by the user using the graphic interface to slide the identifier onto a depicted component, or by the software using lookup tables on a networked database identifying manufacturer known MAC IDs for devices. As shown in FIG. 7 the user has dragged the depicted identifiers 59 to intersect the pixels of the icons 53 relating to system devices, and thereby provided the system 10 software with relational matches of the depicted icon 53 and related device, to the electronic identifier 59 on the LAN 22.

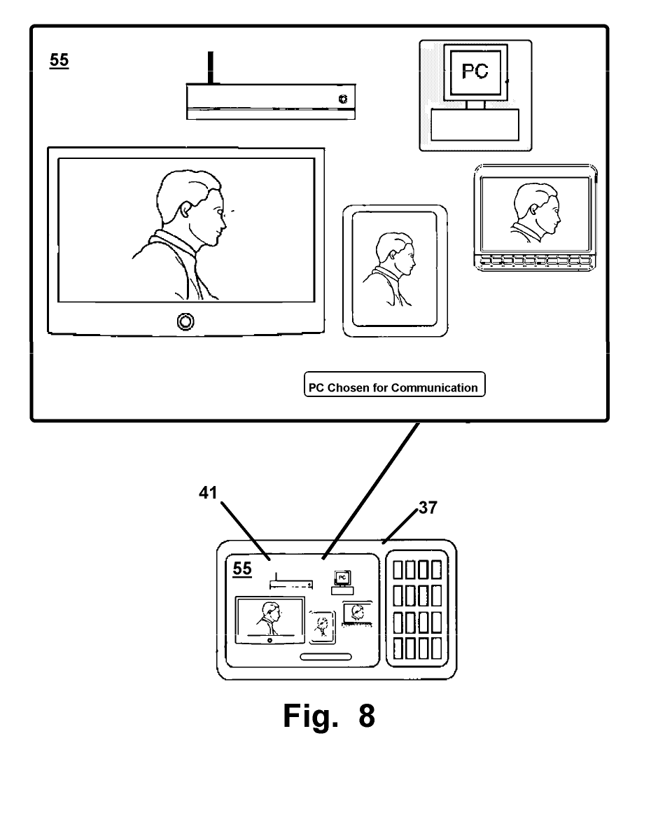

FIG. 8 depicts the graphic interface 55 after the choosing of a component engaged with the LAN 22, which in this case is the highlighted PC. A confirmation is provided on the graphic interface 55 the user has touched or otherwise chosen the device related to the PC which the system has cross referenced with the LAN 22 unique identifier.

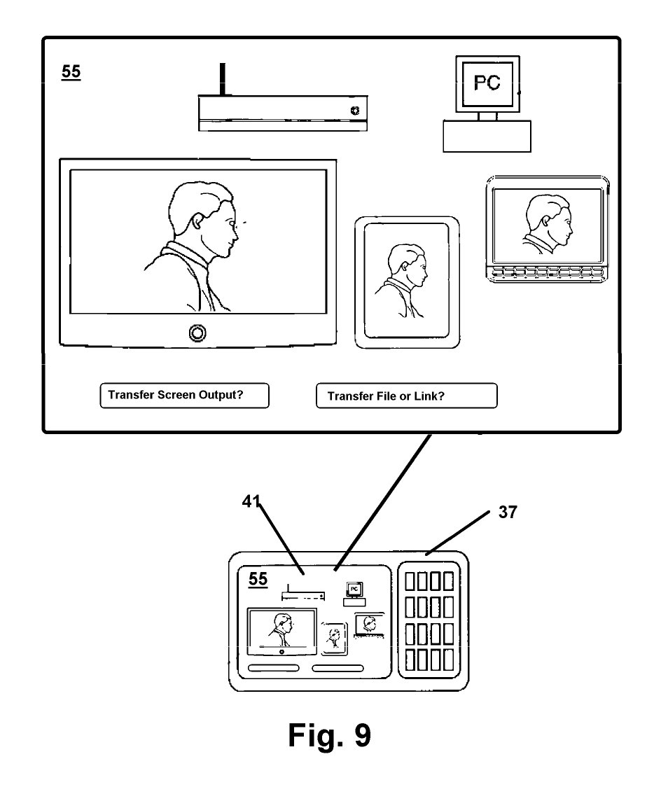

FIG. 9 depicts the screen of the interface 55 provided by the system 10 displayed for the user to input or confirm, what media file, and/or link, and/or media or electronic output signal from another networked device, is to be operatively connected to the user chosen network communicating device, which in this case was the PC. A touch or other interaction with the interface 55 provides the confirmation and the system 10 knowing the IP address relating to the unique identifier of the chosen LAN connected device, will communicate the media, or output to the user chosen device from the interface 55.

While all of the fundamental characteristics and features of the disclosed method and apparatus for interfacing computers and an LAN engaged devices with a video display have been shown and described, a latitude of modification, various changes and substitutions are intended in the foregoing disclosure. It will be apparent that in some instance, some features of the invention may be employed without a corresponding use of other features, or steps may be rearranged for operations, without departing from the scope of the invention as set forth. It should be understood that any such substitutions, modifications, and variations, may be made by those skilled in the art, without departing from the spirit or scope of the invention. Consequently, all such modifications and variations are included within the scope of the invention as defined herein.

What is claimed is:

1. A media interface system for interfacing media between a video display screen, and a plurality of sources of displayable video, comprising:
a control component having a microprocessor having electronic memory and power supply;
said control component operatively engaged with a local network;
software running on said control component configured to receive input electronic signals of video and/or audio communicated in a first electronic standard and output said electronic signals in an output electronic standard;
a plurality of electronic components operatively communicating with said local network;
each of said electronic components having a respective electronic identifier related thereto;
said software running on said control component having a seek routine to ascertain each respective said electronic component communicating with said local network and a respective identifier and a respective network address for each said electronic component ascertained;
said software running on said control component configured to determine which of said electronic components in communication with said network is capable of depicting video;
said software running on said control component having software configured to produce a graphic interface having icons relating to each respective electronic component positioned on said graphic interface;
a hand held said electronic component having a video display for depicting said graphic interface; and
said graphic interface employable by a user to direct said software running on said control component to receive a said input electronic signal over said network from one of said electronic components in said first electronic standard and to communicate said input electronic signal to receiving one of said electronic components in a said output electronic standard employable by said receiving one of said electronic components to reproduce said video and/or audio thereon.

2. The media interface system of claim 1 additionally comprising:
said hand held electronic component having an electronic camera capable of capturing electronic photographs; and
said software running on said control component configured to produce said graphic interface having icons relating to each respective electronic component positioned on said graphic interface, using respective said electronic photographs of said electronic components taken by said camera thereby rendering said icons of said graphic interface as photographs said electronic component to which each said icon relates.

3. The media interface system of claim 2 additionally comprising:
photo recognition software running on said control component adapted to ascertain a manufacturer and model of each said electronic components rendered in a respective said electronic photograph of said electronic components taken by said camera; and
software running on said control component configured to match said manufacturer and model ascertained for each said electronic component to a said electronic identifier.

4. The media interface system of claim 2 additionally comprising:
said software running on said control component configured to produce said graphic interface having icons relating to each respective electronic component positioned on said graphic interface producing a rendition of each discerned electronic identifier on said network, in a first rendition of said graphic interface for said user to match to respective said icons; and
subsequent to said match to respective icons by said user, said software producing said graphic interface without said electronic identifiers thereon.

5. The media interface system of claim 2 additionally comprising:
said graphic interface employable by a user to direct said software running on said control component to communicate said input electronic signal to said receiving one of said electronic components, through activation of an accelerometer by employment of an accelerating gesture in a direction of said receiving one of said electronic components.
